(19) United States
(12) Patent Application Publication
(10) Pub. No.: US 2018/0236698 A1
(43) Pub. Date: Aug. 23, 2018

(54) MOLD ASSEMBLY FOR MOLDING CAR DOOR HANDLE AND METHOD FOR MOLDING CAR DOOR HANDLE USING THE ASSEMBLY

(71) Applicant: DAE HO UM, Gunpo-si (KR)

(72) Inventor: DAE HO UM, Gunpo-si (KR)

(21) Appl. No.: 15/604,185

(22) Filed: May 24, 2017

(30) Foreign Application Priority Data
Feb. 17, 2017 (KR) 10-2017-0021593

(51) Int. Cl. B29C 45/00; B29C 45/14; B29C 45/36

(52) U.S. Cl. CPC B29C 45/0025; B29C 45/14065; B29L 2031/3029; B29C 2045/0034; B29C 45/36

(57) ABSTRACT

There is provided a mold assembly for molding a car door handle, the assembly comprising: a cavity mold as an upper mold, wherein the cavity mold has an elongate cavity defined in an upper body; a core mold as a lower mold, wherein the core mold has an elongate protrusion from a lower body; and first and second inserts received in the molds, wherein each of the first and second inserts has a first curved portion at a first edge of each of the first and second inserts, wherein the cavity mold has a second curved portion at a second edge of each of the first and second cavity mold-side insert-receiving recesses, the second edge abutting the first edge, wherein a parting line for the car door handle is defined as a contact line between the first and second curved portions, wherein the second curved portion extends upward in an upwardly convex shape, while the first curved portion extends downwardly in a downwardly convex shape.

### CROSS-REFERENCE TO RELATED APPLICATION

This application claims the benefit of Korean patent application No. 10-2017-0021593 filed on Feb. 17, 2017, the entire content of which is incorporated herein by reference for all purposes as if fully set forth herein.

### BACKGROUND

### Field of the Present Disclosure

The present disclosure relates to a mold assembly for molding a car door handle and a method for molding a car door handle using the assembly. In particular, the disclosure relates to a mold assembly for molding a car door handle and a method for molding a car door handle using the assembly, whereby in a parting line between upper and lower molds, a resulting car door handle is free of a step or protrusion.

### Discussion of Related Art

In a prior art as shown in FIG. 1, a material is injected into a space between an upper cavity mold 20′ and a lower core mold 30′ to form a car door handle 10′. In this connection, a parting line 11′ is a line at which the two molds are separated from each other. In this parting line, the molded handle tends to have a step or protrusion due to the flow of the material thereto. Therefore, as shown in FIG. 2, a trace of removing this step remains. Further, an inclination between the upper part and the lower part of the molded product 10′ is rapidly changed with respect to the parting line 11′, so that the parting line 11′ is formed into a sharp blade shape.

In order to solve this problem, it is possible to consider a method of changing the surface where the molds are in contact with each other. However, this method is costly and difficult to design. Further, if the shape of the door changes, it is inconvenient to manufacture the mold differently.

### PRIOR ART DOCUMENTS

[Patent Literature] Japanese Patent Laid-Open Publication No. H10-140885

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide a mold assembly for molding a car door handle and a method for molding a car door handle using the assembly, whereby in a parting line between upper and lower molds, a resulting car door handle is free of a step or protrusion.

In one aspect of the present disclosure, there is provided a mold assembly for molding a car door handle, the assembly comprising: a cavity mold as an upper mold, wherein the cavity mold has an elongate cavity defined in an upper body, wherein first and second cavity mold-side insert-receiving recesses are formed in the upper body, wherein the cavity is disposed between the first and second cavity mold-side insert-receiving recesses; a core mold as a lower mold, wherein the core mold has an elongate protrusion from a lower body, wherein first and second core mold-side insert-receiving recesses are formed in the lower body, wherein the cavity mold is coupled to the core mold, wherein the elongate protrusion is disposed between the first and second core mold-side insert-receiving recesses; first and second inserts received in the first and second cavity mold-side insert-receiving recesses and the first and second core mold-side insert-receiving recesses respectively, wherein an empty space is defined between the cavity of the cavity mold and the elongate protrusion of the core mold, and a shape of the empty space corresponds to a shape of a basic frame of the car door handle, wherein each of the first and second inserts has a first curved portion at a first edge of each of the first and second inserts, the edge abutting the empty space, wherein the cavity mold has a second curved portion at a second edge of each of the first and second cavity mold-side insert-receiving recesses, the second edge abutting the first edge and the empty space, wherein a parting line for the car door handle is defined as a contact line between the first and second curved portions, wherein the second curved portion extends upward in an upwardly convex shape, while the first curved portion extends downwardly in a downwardly convex shape.

In one implementation, the first and second cavity-mold side insert-receiving recesses communicate with first and second cavity mold-side through-holes defined in the upper body respectively, wherein the first and second cavity mold-side through-holes communicate with an outside of the cavity mold.

In one implementation, the first and second core-mold side insert-receiving recesses communicate with first and second core mold-side through-holes defined in the lower body respectively, wherein the first and second core mold-side through-holes communicate with an outside of the core mold.

In one implementation, a third through-hole is vertically defined in each of the first and second inserts.

In one implementation, the first and second cavity mold-side through-holes, the first and second core mold-side through-holes and the pair of the third through-holes are vertically aligned with each other in a linear manner respectively, thereby to define first and second vertically passing-through holes defined in the mold assembly, wherein first and second alignment pins are inserted into the first and second vertically passing-through holes respectively.

In one implementation, each of the first and second inserts has a lower portion and an upper portion, wherein the upper portion has a protrusion, wherein the protrusion has a top face, and inner and outer side faces, wherein the outer side face has a larger vertical length than the inner side face, wherein the outer side face of the upper portion is more inwardly positioned than an outer side face of the lower portion such that there is an outer step between the upper and lower portions, and the inner side face of the upper portion is more outwardly positioned than an inner side face of the lower portion such that there is an inner step between the upper and lower portions of the first insert, wherein the inner step is positioned at a higher level than the outer step.

In one implementation, each of the first and second inserts has a lower portion and an upper portion, wherein the upper portion has a protrusion, wherein the protrusion has a top face, and inner and outer side faces, wherein the outer side face has the same vertical length as the inner side face, wherein the outer side face of the upper portion is more inwardly positioned than an outer side face of the lower portion such that there is an outer step between the upper and lower portions, and the inner side face of the upper portion is more outwardly positioned than an inner side face of the lower portion such that there is an inner step between the upper and lower portions of the first insert, wherein the inner step is positioned at the same level as the outer step.

In another aspect of the present disclosure, there is provided a method for molding a car door handle, the method comprising: providing a cavity mold as an upper mold, wherein the cavity mold has an elongate cavity defined in an upper body, wherein first and second cavity mold-side insert-receiving recesses are formed in the upper body, wherein the cavity is disposed between the first and second cavity mold-side insert-receiving recesses; providing a core mold as a lower mold, wherein the core mold has an elongate protrusion from a lower body, wherein first and second core mold-side insert-receiving recesses are formed in the lower body, wherein the elongate protrusion is disposed between the first and second core mold-side insert-receiving recesses; inserting first and second inserts into the first and second core mold-side insert-receiving recesses respectively, wherein each of the first and second inserts has a first curved portion at a first edge of each of the first and second inserts, the edge abutting an empty space defined between the cavity and the elongate protrusion; and coupling the cavity mold to the core mold such that the first and second inserts are received into the first and second cavity mold-side insert-receiving recesses and such that an empty space is defined between the cavity of the cavity mold and the elongate protrusion of the core mold, and a shape of the empty space corresponds to a shape of a basic frame of the car door handle, wherein the cavity mold has a second curved portion at a second edge of each of the first and second cavity mold-side insert-receiving recesses, the second edge abutting the first edge and the empty space, wherein a parting line for the car door handle is defined as a contact line between the first and second curved portions, wherein the second curved portion extends upward in an upwardly convex shape, while the first curved portion extends downwardly in a downwardly convex shape.

According to the present invention, the curved portions of the first and second inserts may be finely polished to reduce roughness thereof, thereby to maintain a gentle round shape of the curved portion. Thus, at the parting line, it is possible to prevent a sharp burr from occurring. In addition, even when the curved portion of the cavity mold is deformed or twisted, the curved portions of the first and second inserts may be polished to be adapted to the deformation or twist without changing the parting face of the core mold as in the prior art. This is advantageous even in a long-term harsh working environment.

According to the present invention, the first and second alignment pins are inserted into the first and second vertically passing-through holes respectively. Thus, the inserts are prevented from moving or skewing finely due to the clearance between the body and inserts. For this reason, the disadvantage that the dimension of the final molded product is not uniform and not precise is removed. That is, the precision of the final formed product can be greatly improved. In addition, after the product molding is completed, the mold assembly can be easily reassembled without any inconvenience.

In accordance with the present disclosure, the inner step is positioned at a higher level than the outer step. This is distinguishable from the conventional configuration where the inner step is positioned at the same level as the outer step. Since, in accordance with the present disclosure, the inner step is positioned at a higher level than the outer step, the contact area between the cavity mold and the core mold may be more increased. Thus, in accordance with the present disclosure, the car door handle may be more stably supported than in the conventional configuration where the inner step is positioned at the same level as the outer step.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a cross-sectional view of a mold assembly for molding a car door handle in accordance with the prior art.

FIG. 2 is a perspective view illustrating a parting line of a car door handle according to the prior art.

FIG. 3 is an exploded perspective view of a mold assembly for molding a car door handle according to one embodiment of the present invention.

FIG. 4 is a perspective view showing a state in which a pair of inserts are seated on a base of a core mold as a lower mold according to an embodiment of the present invention.

FIG. 5 is a perspective view showing a state in which lower and upper molds of a mold assembly in FIG. 3 are coupled to each other.

FIG. 6 is a cross-sectional view showing a state in which a car door handle is manufactured using the mold assembly according to an embodiment of the present invention.

FIG. 7 is a perspective view of a car door handle removed from the mold assembly according to an embodiment of the present invention.

FIG. 8 is an exploded perspective view of a mold assembly for molding a car door handle according to another embodiment of the present invention.

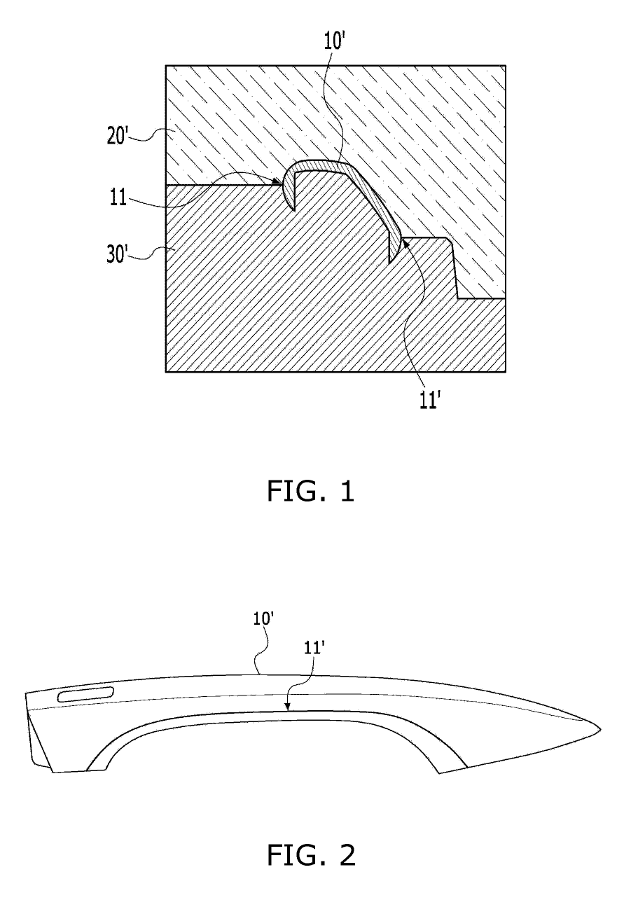

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTION

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated ₉0 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

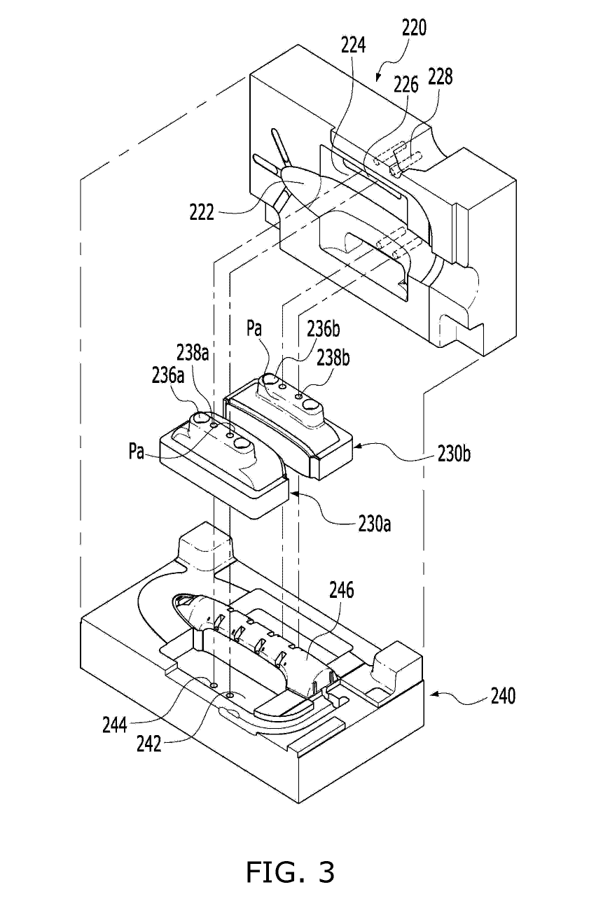

FIG. 3 is an exploded perspective view of a mold assembly for molding a car door handle according to one embodiment of the present invention. The mold assembly includes a cavity mold 220 as an upper mold and a core mold 240 as a lower mold. The core mold 240 receives a first insert 230a and a second insert 230b.

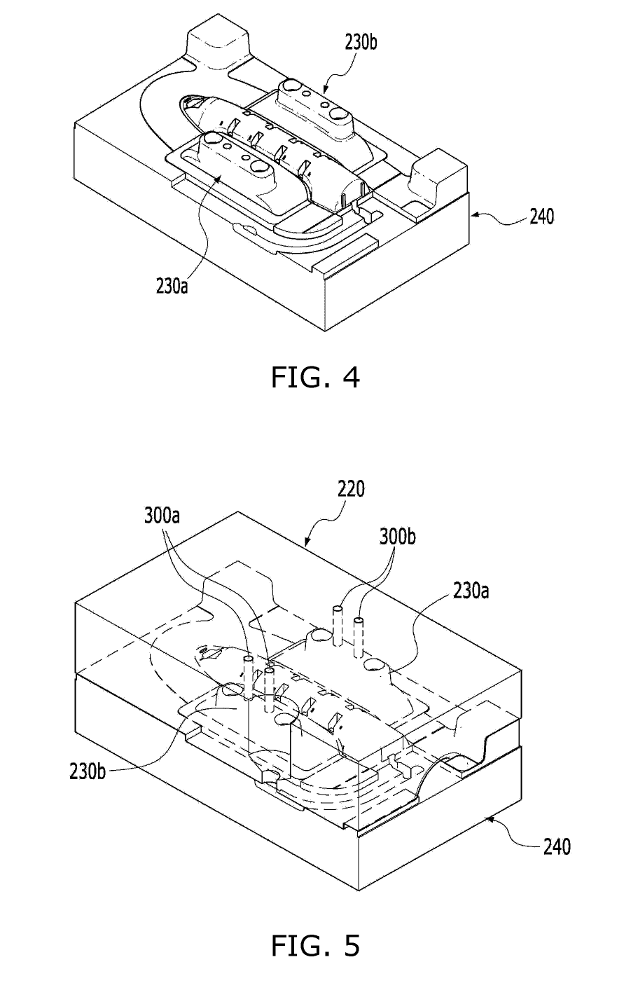

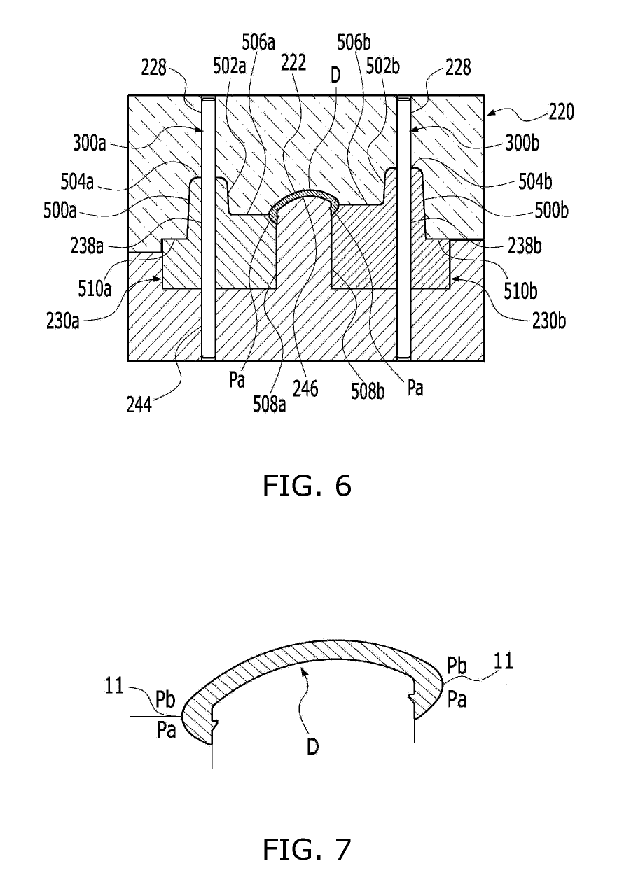

FIG. 4 is a perspective view showing a state in which the pair of inserts 230a and 230b are seated on a base of the core mold 240 as the lower mold according to an embodiment of the present invention. FIG. 5 is a perspective view showing a state in which the lower and upper molds 220 and 230 of the mold assembly in FIG. 3 are coupled to each other. FIG. 6 is a cross-sectional view showing a state in which a car door handle is manufactured using the mold assembly according to an embodiment of the present invention.

First, as shown in FIG. 3, the cavity mold 220 is symmetrically formed with respect to an elongate cavity 222 formed at the center of the body 224 thereof. First and second cavity mold-side insert-receiving recesses 226 are formed in the body 224 of the cavity mold in a symmetrical manner with respect to the cavity 222. The first and second cavity-mold side insert-receiving recesses 226 communicate with first and second cavity mold-side through-holes 228 defined in the body 224 respectively. The first and second cavity mold-side through-holes 228 communicate with the outside of the mold 220. The cavity mold 220 is coupled to the core mold 240.

The core mold 240 is symmetrically formed with respect to an elongate protrusion 246 formed at the center of a body 242 thereof. First and second core mold-side insert-receiving recesses are formed in the body 242 of the core mold in a symmetrical manner with respect to the protrusion 246. The first and second core-mold side insert-receiving recesses communicate with first and second core mold-side through-holes 244 defined in the body 242 respectively. The first and second core mold-side through-holes 244 communicate with the outside of the mold 240.

When the cavity mold 220 is coupled to the core mold 240, an empty space is defined between the cavity 222 of the cavity mold 220 and the elongate protrusion 246 of the core mold 240. The shape of this empty space corresponds to the shape of the basic frame of the car door handle. This empty space is filled with a material for the door handle.

The first and second inserts 230a and 230b are rested on the body 242 of the core mold 240 as the lower mold, as shown in FIG. 4. The first and second inserts 230a and 230b have the same structure. Therefore, the first insert 230a will be mainly described.

Referring to FIG. 3 and FIG. 6, the first insert 230a has a lower portion 510a, and an upper portion 506a. The upper portion 506a has a protrusion, wherein the protrusion has a top face 504a, and both side faces 500a and 502a, wherein the outer side face 500a has a larger vertical length than the inner side face 502a.

The outer side face 500a of the upper portion 506a is more inwardly positioned than an outer side face of the lower portion 510a. Thus, there is an outer step between the upper and lower portions of the first insert 230a. The inner side face 502a of the upper portion 506a is more outwardly positioned than an inner side face of the lower portion 510a. Thus, there is an inner step between the upper and lower portions of the first insert 230a.

In this way, the first insert 230a is formed in asymmetrical manner between the outer and inner sides thereof.

In accordance with the present disclosure, the inner step is positioned at a higher level than the outer step. This is distinguishable from the conventional configuration where the inner step is positioned at the same level as the outer step. Since, in accordance with the present disclosure, the inner step is positioned at a higher level than the outer step, the contact area between the cavity mold 220 and the core mold 240 may be more increased. Thus, in accordance with the present disclosure, the car door handle D may be more stably supported than in the conventional configuration where the inner step is positioned at the same level as the outer step.

The first insert 230a has a pair of third through-holes 238a vertically defined therein. Holes 236a may be formed via polishing.

The mold assembly for molding the car door handle may be completed by inserting the lower portions of the first and second inserts 230a and 230b into the first and second core-mold side insert-receiving recesses respectively defined in the core mold 240 and engaging the first and second cavity-mold side insert-receiving recesses with the upper portion of the first and second inserts 230a and 230b respectively.

In this connection, the first and second cavity mold-side through-holes 228, the first and second core mold-side through-holes 244 and the pair of the third through-holes 238a and 238b may be aligned with each other in a linear manner respectively as shown in FIG. 6, thereby to define first and second vertically passing-through holes defined in the mold assembly. Then, first and second alignment pins 300a and 300b may be inserted into the first and second vertically passing-through holes respectively.

In the prior art, for example, when the first and second inserts 230a and 230b are received in the body 242 of the core mold 240, there is a problem that the inserts move or skew finely due to the clearance between the body and inserts. For this reason, there is a disadvantage that the dimension of the final molded product is not uniform and not precise.

However, in accordance with the present disclosure, when the mold assembly for molding the car door handle is completed by inserting the lower portions of the first and second inserts 230a and 230b into the first and second core-mold side insert-receiving recesses respectively defined in the core mold 240 and engaging the first and second cavity-mold side insert-receiving recesses with the upper portion of the first and second inserts 230a and 230b respectively, the first and second cavity mold-side through-holes 228, the first and second core mold-side through-holes 244 and the pair of the third through-holes 238a and 238b are aligned with each other in a linear manner respectively as shown in FIG. 6, thereby to define first and second vertically passing-through holes defined in the mold assembly, and, then, the first and second alignment pins 300a and 300b are inserted into the first and second vertically passing-through holes respectively. Thus, the inserts are prevented from moving or skewing finely due to the clearance between the body and inserts. For this reason, the disadvantage that the dimension of the final molded product is not uniform and not precise is removed. That is, the precision of the final formed product can be greatly improved. In addition, after the product molding is completed, the mold assembly can be easily reassembled without any inconvenience.

Hereinafter, the formation of the parting line 11 for the car door handle D according to an embodiment of the present invention will be described with reference to FIG. 6 and FIG. 7.

The base frame of the car door handle D corresponds to an empty space formed between the cavity 222 of the cavity mold 220 and the elongate protrusion 246 of the core mold 240. The features involved in forming the parting line 11 for the car door handle D are the curved portion Pb of the cavity mold 220 and the curved portions Pa of the first and second inserts 230a and 230b. In particular, a portion defined between the curved portions Pa and Pb form the parting line 11.

With respect to the parting line 11, the curved portion Pb extends upward in an upwardly convex shape. The curved portion Pa extends downwardly in a downwardly convex shape. By changing the radius of curvature of the curved portion Pa, it is possible to finely adjust the parting line 11 and a shape of its surrounding door handle portion. Thus, it is possible to prevent a step or flash from occurring.

In FIG. 6 and FIG. 7, for the car door handle D, the right parting line 11 is formed at a position higher than the left parting line 11, but the present invention is not limited thereto. The position of the parting line 11 may vary depending on the specification.

According to an embodiment of the present invention, the curved portions Pa of the first and second inserts 230a and 230b may be finely polished to reduce roughness thereof, thereby to maintain a gentle round shape of the curved portion. Thus, at the parting line 11, it is possible to prevent a sharp burr from occurring. In addition, even when the curved portion Pb of the cavity mold 220 is deformed or twisted, the curved portions Pa of the first and second inserts 230a and 230b may be polished to be adapted to the deformation or twist without changing the parting face of the core mold 240 as in the prior art. This is advantageous even in a long-term harsh working environment.

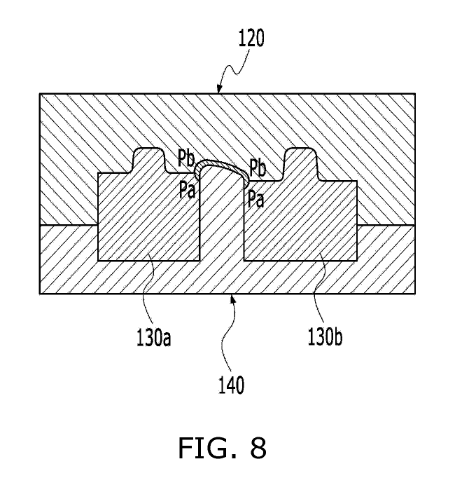

FIG. 8 is an exploded perspective view of a mold assembly for molding a car door handle according to another embodiment of the present invention.

In accordance with this embodiment of the present disclosure, as for each of the first insert 130a and the second insert 130b, the inner step is positioned at the same level than the outer step. Further, the shapes of the cavity mold 120 and the core mold 140 are deformed depending on change in the shapes of the first and second inserts 130a and 130b.

In the embodiment of the present disclosure as shown in FIG. 8, the base frame of the car door handle D corresponds to an empty space formed between the cavity 222 of the cavity mold 220 and the elongate protrusion 246 of the core mold 240. The features involved in forming the parting line 11 for the car door handle D are the curved portion Pb of the cavity mold 220 and the curved portions Pa of the first and second inserts 230a and 230b. In particular, a portion defined between the curved portions Pa and Pb form the parting line 11. With respect to the parting line 11, the curved portion Pb extends upward in an upwardly convex shape. The curved portion Pa extends downwardly in a downwardly convex shape. By changing the radius of curvature of the curved portion Pa, it is possible to finely adjust the parting line 11 and a shape of its surrounding door handle portion. Thus, it is possible to prevent a step or flash from occurring. According this embodiment of the present invention, the curved portions Pa of the first and second inserts 230a and 230b may be finely polished to reduce roughness thereof, thereby to maintain a gentle round shape of the curved portion. Thus, at the parting line 11, it is possible to prevent a sharp burr from occurring.

It is to be understood that while the present disclosure has been particularly shown and described with reference to the exemplary embodiments thereof, the disclosure is not limited to the disclosed exemplary embodiments. On the contrary, it will be understood by those skilled in the art that various modifications may be made without departing from the spirit and scope of the present disclosure.

It is understood by those skilled in the art that various variants and alternatives may be selected in the present disclosure without departing from the spirit or scope of the present disclosure. Accordingly, it is intended that the present disclosure covers the modifications and variations when they come within the scope of the appended claims and their equivalents.

### REFERENCE NUMERALS

220: cavity mold 240: core mold 230a: first insert 230b: second insert
222: cavity 228: first and second cavity mold-side through-holes
244: first and second core mold-side through-holes
238a, 238b: third through-holes
300a, 300b: alignment pins
D: car door handle
11: parting line
Pa, Pb: curved portions

What is claimed is:

1. A mold assembly for molding a car door handle, the assembly comprising:
a cavity mold as an upper mold, wherein the cavity mold has an elongate cavity defined in an upper body, wherein first and second cavity mold-side insert-receiving recesses are formed in the upper body, wherein the cavity is disposed between the first and second cavity mold-side insert-receiving recesses;
a core mold as a lower mold, wherein the core mold has an elongate protrusion from a lower body, wherein first and second core mold-side insert-receiving recesses are formed in the lower body, wherein the cavity mold is coupled to the core mold, wherein the elongate protrusion is disposed between the first and second core mold-side insert-receiving recesses;
first and second inserts received in the first and second cavity mold-side insert-receiving recesses and the first and second core mold-side insert-receiving recesses respectively,
wherein an empty space is defined between the cavity of the cavity mold and the elongate protrusion of the core mold, and a shape of the empty space corresponds to a shape of a basic frame of the car door handle,
wherein each of the first and second inserts has a first curved portion at a first edge of each of the first and second inserts, the edge abutting the empty space,
wherein the cavity mold has a second curved portion at a second edge of each of the first and second cavity mold-side insert-receiving recesses, the second edge abutting the first edge and the empty space,
wherein a parting line for the car door handle is defined as a contact line between the first and second curved portions,
wherein the second curved portion extends upward in an upwardly convex shape, while the first curved portion extends downwardly in a downwardly convex shape.

2. The assembly of claim 1, wherein the first and second cavity-mold side insert-receiving recesses communicate with first and second cavity mold-side through-holes defined in the upper body respectively, wherein the first and second cavity mold-side through-holes communicate with an outside of the cavity mold.

3. The assembly of claim 2, wherein the first and second core-mold side insert-receiving recesses communicate with first and second core mold-side through-holes defined in the lower body respectively, wherein the first and second core mold-side through-holes communicate with an outside of the core mold.

4. The assembly of claim 3, wherein, and a third through-hole is vertically defined in each of the first and second inserts.

5. The assembly of claim 4, wherein the first and second cavity mold-side through-holes, the first and second core mold-side through-holes and the pair of the third through-holes are vertically aligned with each other in a linear manner respectively, thereby to define first and second vertically passing-through holes defined in the mold assembly, wherein first and second alignment pins are inserted into the first and second vertically passing-through holes respectively.

6. The assembly of claim 1, wherein each of the first and second inserts has a lower portion and an upper portion, wherein the upper portion has a protrusion, wherein the protrusion has a top face, and inner and outer side faces, wherein the outer side face has a larger vertical length than the inner side face, wherein the outer side face of the upper portion is more inwardly positioned than an outer side face of the lower portion such that there is an outer step between the upper and lower portions, and the inner side face of the upper portion is more outwardly positioned than an inner side face of the lower portion such that there is an inner step between the upper and lower portions of the first insert, wherein the inner step is positioned at a higher level than the outer step.

7. The assembly of claim 1, wherein each of the first and second inserts has a lower portion and an upper portion, wherein the upper portion has a protrusion, wherein the protrusion has a top face, and inner and outer side faces, wherein the outer side face has the same vertical length as the inner side face, wherein the outer side face of the upper portion is more inwardly positioned than an outer side face of the lower portion such that there is an outer step between the upper and lower portions, and the inner side face of the upper portion is more outwardly positioned than an inner side face of the lower portion such that there is an inner step between the upper and lower portions of the first insert, wherein the inner step is positioned at the same level as the outer step.

8. A method for molding a car door handle, the method comprising:
providing a cavity mold as an upper mold, wherein the cavity mold has an elongate cavity defined in an upper body, wherein first and second cavity mold-side insert-receiving recesses are formed in the upper body, wherein the cavity is disposed between the first and second cavity mold-side insert-receiving recesses;
providing a core mold as a lower mold, wherein the core mold has an elongate protrusion from a lower body, wherein first and second core mold-side insert-receiving recesses are formed in the lower body, wherein the elongate protrusion is disposed between the first and second core mold-side insert-receiving recesses;
inserting first and second inserts into the first and second core mold-side insert-receiving recesses respectively, wherein each of the first and second inserts has a first curved portion at a first edge of each of the first and second inserts, the edge abutting an empty space defined between the cavity and the elongate protrusion;
coupling the cavity mold to the core mold such that the first and second inserts are received into the first and second cavity mold-side insert-receiving recesses and such that an empty space is defined between the cavity of the cavity mold and the elongate protrusion of the core mold, and a shape of the empty space corresponds to a shape of a basic frame of the car door handle,
wherein the cavity mold has a second curved portion at a second edge of each of the first and second cavity mold-side insert-receiving recesses, the second edge abutting the first edge and the empty space,
wherein a parting line for the car door handle is defined as a contact line between the first and second curved portions,
wherein the second curved portion extends upward in an upwardly convex shape, while the first curved portion extends downwardly in a downwardly convex shape.

9. The method of claim 8, wherein the first and second cavity-mold side insert-receiving recesses communicate with first and second cavity mold-side through-holes defined in the upper body respectively, wherein the first and second cavity mold-side through-holes communicate with an outside of the cavity mold.

10. The method of claim 9, wherein the first and second core-mold side insert-receiving recesses communicate with first and second core mold-side through-holes defined in the lower body respectively, wherein the first and second core mold-side through-holes communicate with an outside of the core mold.

11. The method of claim 10, wherein a third through-hole is vertically defined in each of the first and second inserts.

12. The method of claim 11, wherein the first and second cavity mold-side through-holes, the first and second core mold-side through-holes and the pair of the third through-holes are vertically aligned with each other in a linear manner respectively, thereby to define first and second vertically passing-through holes defined in the mold assembly, wherein first and second alignment pins are inserted into the first and second vertically passing-through holes respectively.

13. The method of claim 8, wherein each of the first and second inserts has a lower portion and an upper portion, wherein the upper portion has a protrusion, wherein the protrusion has a top face, and inner and outer side faces, wherein the outer side face has a larger vertical length than the inner side face, wherein the outer side face of the upper portion is more inwardly positioned than an outer side face of the lower portion such that there is an outer step between the upper and lower portions, and the inner side face of the upper portion is more outwardly positioned than an inner side face of the lower portion such that there is an inner step between the upper and lower portions of the first insert, wherein the inner step is positioned at a higher level than the outer step.
